(19) United States
(12) Patent Application Publication
(10) Pub. No.: US 2010/0013959 A1
(43) Pub. Date: Jan. 21, 2010

(54) Efficient Generation Of A Reflection Effect

(76) Inventor: Barinder Singh Rai, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/175,168

(22) Filed: Jul. 17, 2008

(51) Int. Cl. H04N 5/907

(52) U.S. Cl. 348/231.99

(57) ABSTRACT

In one embodiment, a method generates an output image having a reflection special effect at the time of capture of an original image having a first area. The output image is generated using a memory having a capacity limited to storing a single image and a buffer having a capacity limited to storing one line of the original image. The first area of the original image is stored in the memory at memory locations corresponding with an unmodified region of the output image and in the buffer. Modified pixels and addresses are generated. The modified pixels are stored in the memory. Each modified pixel is generated from one or more pixels of the first area stored in the buffer. Addresses for storing each modified pixel are generated according to a reflection mapping function and an offset mapping function. The output image is fetched from memory and rendered.

### FIELD

The present invention relates generally to digital photography and more particularly to efficiently generating a reflection special effect at the time an image is captured.

### BACKGROUND

If a scene includes a reflective surface, e.g., a body of water, images of one or more objects may appear as reflections in a photograph of the scene. The reflective surface is often not uniform, e.g., the water may be rippled with waves, in which case the reflection may be a distorted or blurred version of the original objects.

A digital image may be captured with a digital camera or with a hand-held mobile device, such as a cellular telephone. After a digital image has been captured, software running on a personal computer (“PC”) may be used to manipulate the image to generate a synthetic reflection effect. Such software generally requires a program memory to store the software and a data memory to store two or more full copies of the image. Image manipulation software of this type generally requires an operating system, which also requires a significant amount of memory. Further, image manipulation software requires a powerful processor, such as is found in a modern PC and which are commercially available from Intel and AMD. These processors are physically large, and may require special mounting and a heat sink. A powerful processor additionally requires significant amounts of power. It is readily apparent that significant amounts of hardware, processing overhead, and power are required when image manipulation software is used to create a synthetic reflection effect. Digital cameras and hand-held mobile devices are typically battery powered and are subject to severe constraints on the size of the device. For these reasons, it is not practical to employ known image manipulation software to generate an image having a synthetic reflection effect in a digital camera or hand-held mobile device.

In addition, image manipulation software is executed post-process, i.e., after an image is captured and transferred to a PC. Accordingly, when such programs are used, the result of the image manipulation is not seen in a camera display at the time the photograph is captured. Further, PC-based image manipulation software operates on one image at a time and is not suited or intended for generating a video image having a synthetic reflection effect.

Accordingly, there is a need for methods and apparatus for efficiently generating an image having a reflection special effect at the time of image capture. In particular, there is a need for methods and apparatus for minimizing the hardware, power consumption, and the speed with which an image having a reflection special effect may be generated.

### SUMMARY

One embodiment that addresses the needs described in the background is directed to a method. The method generates an output image having a reflection special effect at the time of capture of an original image. It should be understood that the original image has a first area and the output image has a modified and an unmodified region. The output image is generated using a memory having a capacity limited to storing a single image. A buffer having a capacity limited to storing one line of the original image is also used.

The method includes storing the first area of the original image in the memory at memory locations corresponding with the unmodified region of the output image. In addition, the first area of the original image is stored in the buffer. Further, modified pixels are stored in the memory at memory locations corresponding with the modified region of the output image. The storing of the modified pixels includes generating modified pixels and generating addresses. Each modified pixel is generated from one or more pixels of the first area stored in the buffer. Addresses identifying memory locations for storing each modified pixel are generated according to a reflection mapping function and an offset mapping function. The method additionally includes rendering the output image, which includes fetching the output image from the memory.

One embodiment is directed to an apparatus for generating an output image having a reflection special effect at the time an original image is captured. It should be understood that the original image has a first area and the output image has a modified and an unmodified region. The apparatus includes a memory to store the output image. The memory has a capacity limited to storing a single output image. The apparatus also includes a buffer having a capacity limited to storing one line of the original image. In addition, the apparatus may include a receiving unit, a calculating unit, and a fetching unit. The receiving unit receives and stores the first area of the original image in the memory at memory locations corresponding with the modified region of the output image and in the buffer. The first area of the original image is stored in the memory at memory locations corresponding with the unmodified region of the output image. The calculating unit: (a) generates modified pixels for each pixel location of the modified region from one or more pixels of the first area stored in the buffer; and (b) stores the modified pixels in the memory at memory locations generated according to a reflection mapping function and an offset mapping function. The fetching unit fetches the output image from the memory and transmits the output image to a display device.

Another embodiment is directed to a method for generating an output image having a reflection special effect at the time of capture of an original image. The original image has a first area. The output image has a modified and an unmodified region. The output image is generated using a memory having a capacity limited to storing a single image and a buffer having a capacity limited to storing one line of the original image.

The method includes storing the original image in the memory. In addition, the method includes transmitting to a display device the unmodified region of the output image. The transmitting of the unmodified region to the display device may include fetching the first area of the original image from the memory. Additionally, the first area of the original image is stored in the buffer. The modified region of the output image is transmitted to a display device. The transmitting of the modified region to the display device may include generating modified pixels. Each modified pixel is generated from one or more pixels of the first area stored in the buffer. Modified pixels may be provided for transmission in an order defined by a reflection mapping function and an offset mapping function. The method includes rendering the output image on the display device.

An additional embodiment is directed to an apparatus for generating an output image having a reflection special effect at the time an original image is captured. The original image has a first area. The output image has a modified and an unmodified region. The apparatus includes a memory to store the original image. The memory has a capacity limited to storing a single original image. In addition, the apparatus includes a buffer having a capacity limited to storing one line of the original image. The apparatus may also include a fetching unit, a calculating unit, and a transmitting unit. The fetching unit fetches pixels of the first area of the original image from the memory for transmission to a display device. Fetched pixels are also stored in the buffer. The calculating unit generates modified pixels and may map the modified pixels into pixel locations. Modified pixels are generated for each pixel location of the modified region from one or more pixels of the first area stored in the buffer. Modified pixels may be mapped into pixel locations in the display area of the display device according to a reflection mapping function and an offset mapping function. The transmitting unit transmits the first area and the modified pixels to the display device as the output image.

According to the principles of the invention, a reflection special effect may be generated at the time of image capture without providing a powerful processor or increasing an internal clock rate, and without providing a large data memory for storing multiple image copies or a program memory for storing software. In addition, a video image having a reflection special effect may be generated without increasing internal clock speed or incurring other disadvantages associated with software.

This summary is provided to generally describe what follows in the drawings and detailed description and is not intended to limit the scope of the invention. Objects, features, and advantages of the invention will be readily understood upon consideration of the following detailed description taken in conjunction with the accompanying drawings.

### BRIEF DESCRIPTION OF THE DRAWINGS

FIG. 1 is a block diagram of one embodiment of a display system having a display controller, which includes an internal memory, a buffer, and a calculating unit.

FIG. 2 illustrates a raster scan pattern.

FIG. 3 shows an exemplary original image and an exemplary output image.

FIG. 4 shows one example of the memory of FIG. 1 in greater detail.

FIG. 5 is an alternative depiction of the memory of FIG. 1.

FIG. 6 illustrates a bottom-up raster scan pattern.

FIG. 7 is a block diagram of one embodiment of the buffer and calculating unit of FIG. 1.

FIG. 8 illustrates exemplary offset parameters.

FIG. 9 shows exemplary output images.

FIG. 10 shows a portion of the memory depicted in FIG. 5.

FIG. 11 shows an example of an output image according to one alternative.

FIG. 12 shows another example of an output image according to another alternative.

FIG. 13 is a simplified block diagram of one alternative embodiment of the display controller of FIG. 1.

FIG. 14 is one embodiment of a state diagram for a buffer control circuit for the buffer of FIG. 1.

In the drawings and description below, the same reference numbers are used in the drawings and the description generally to refer to the same or like parts, elements, or steps.

### DETAILED DESCRIPTION

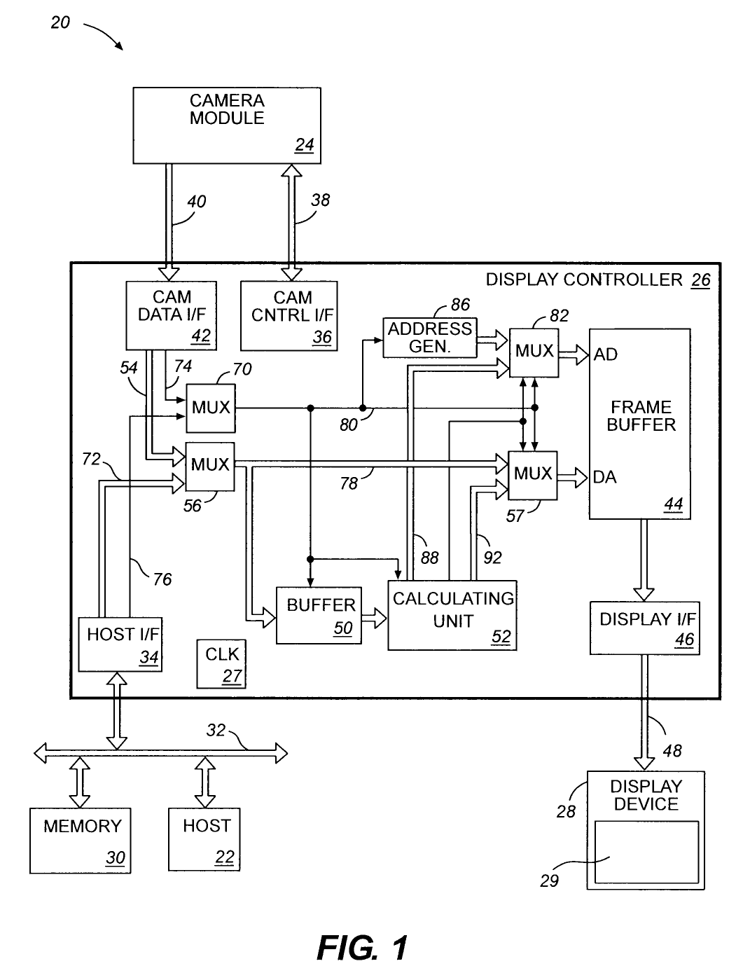

FIG. 1 is a block diagram of one embodiment of a system 20. The system 20 includes a host 22, a camera module 24, a display controller 26, a display device 28 having a display area 29, and a memory 30.

The host 22 may be a microprocessor, a DSP, computer, or any other type of device for controlling a system 20. The host 22 may control operations by executing instructions that are stored in or on machine-readable media. The host 22 may communicate with the display controller 26, the memory 30, and other system components over a bus 32. The bus 32 may be coupled with a host interface 34 in the display controller 26.

The camera module 24 may be coupled with a camera control interface 36 (“CAM CNTRL I/F”) within the display controller 26 via a bus 38. The display controller 26 may use the camera control interface 36 to programmatically control the camera module 24. Further, the display controller 26 may provide a clock signal to the camera module 24 or read camera registers using the bus 38. The camera module 24 may also be coupled via a bus 40 with a camera data interface 42 (“CAM DATA I/F”) in the display controller 26. The camera module 24 outputs image data on the bus 40. In addition, the camera module 24 may place vertical and horizontal synchronizing signals on the bus 40 for marking the ends of frames and lines in the data stream.

The display controller 26 interfaces the host 22 and the camera module 24 with the display device 28. The display controller 26 may include a memory 44. In one embodiment, the memory 44 serves as a frame buffer for storing image data. In addition, in one embodiment, the capacity of the memory 44 is limited so that no more than a single frame may be stored at any one time in order to minimize power consumption and chip size. The display controller 26 may also include a display device interface 46 (“DISPLAY I/F”). The display device interface 46 transmits pixel data to the display device 28 in accordance with the timing requirements and refresh rate of the display. In addition, the display controller 26 includes additional units and components that will be described below. The display controller 26 may be a separate integrated circuit from the remaining elements of the system 20, that is, the display controller may be “remote” from the host 22, camera module 24, and display device 28.

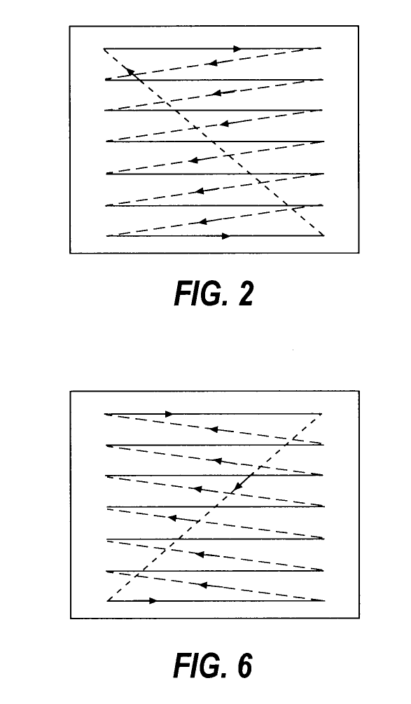

The camera module 24 may output image data in frames. A frame is a two-dimensional array of pixels. Frames output by the camera module 24 may be referred to in this description as “original” images or frames. The camera module 24 may output frames in either of “photo” or video modes. In addition, the camera module 24 may output the pixel data comprising a frame in a predetermined order. In one embodiment, the camera module 24 outputs frames in raster order. FIG. 2 illustrates a raster scan pattern. A raster scan pattern begins with the left-most pixel on the top line of the array and proceeds pixel-by-pixel from left-to-right. After the last pixel on the top line, the raster scan pattern jumps to the left-most pixel on the second line of the array. The raster scan pattern continues in this manner scanning each successively lower line until it reaches the last pixel on the last line of the array.

Referring again to FIG. 1, the display controller 26 may receive a single frame (in photo mode) or a sequence of frames (in video mode) from the camera module 24. A frame or individual frames of a sequence received by the display controller 26 may be stored in the memory 44. A frame may be stored in the memory 44 by overwriting a previously stored frame. The frame stored in the memory 44 may be fetched and presented to the display device 28, where it may be rendered. The fetched frame may be transmitted to the display device 28 via the display device interface 46 and a display device bus 48. The frame sent to the display device 28 may be rendered in the display area 29 and may be referred to in this description as an “output” image or frame. The display device 28 may be an LCD, but any device capable of rendering pixel data in visually perceivable form may be employed. For example, the display device 28 may be a CRT, LED, OLED, plasma, or electrophoretic display device.

The display controller 26 may also include a buffer 50 and a calculating unit 52. The calculating unit 52 may be coupled with the buffer 50 and memory 44 as shown in FIG. 1. Image data output from the camera module 24 may be placed on a bus 54 by the camera data interface 42 which is coupled with a data input to a multiplexer 56. The image data may be output from the multiplexer 56 and presented to both the buffer 50 and, via a multiplexer 57, to the memory 44. Using pixel data stored in the buffer 50, the calculating unit 52 may compute and store modified pixels in the memory 44 via the multiplexer 57. The display controller 26 may include a clock 27 for generating one or more internal clock signals.

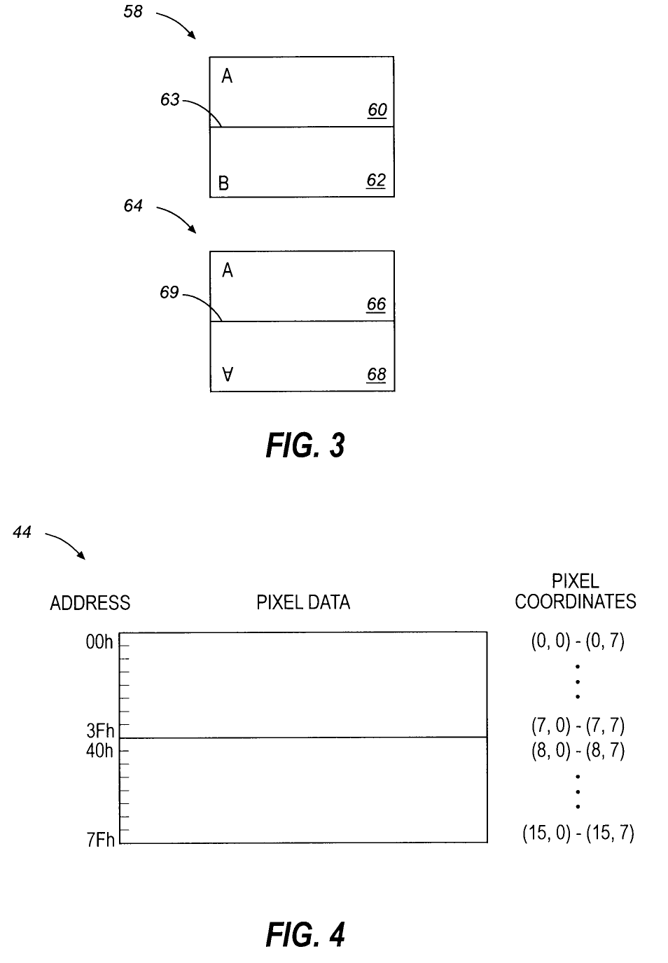

FIG. 3 shows an exemplary original image 58 output by the camera module 24 in its original orientation. The original image 58 may have a first area 60 and second area 62 as shown. An axis 63 divides the original image into the two areas. FIG. 3 also shows an exemplary output image 64 which may be output by the display controller 26. The output image 64 may have an unmodified region 66 and a modified region 68 as shown. An axis 69 divides the output image into the two regions. As indicated by positioning of the letter A, the unmodified region 66 may be a replica of the first area 60 and the modified region 68 may be a reflected version of the first area 60.

FIG. 4 shows one example of the memory 44 in greater detail. In this simplified example, the memory 44 has 16 rows and each row is eight bytes wide, which corresponds with a frame having eight columns and 16 rows of eight-bit pixels. The memory addresses of the left-most byte of selected rows are shown on the left side of the figure. The coordinate locations for each of the pixels in an output frame 64 that may be stored in the memory 44 are shown on the right side of the figure. Like the output image, the memory 44 may be divided into two portions. In this example, the portion having addresses 00h to 3Fh is allocated for storing the unmodified region 66 of the output frame 64. The unmodified region 66 has coordinates ranging from (0, 0) to (7, 7). In addition, the portion having addresses at 40h to 7Fh is allocated for storing the modified region 68. The modified region 68 has coordinates ranging from (8, 0) to (15, 7).

In the example presented in FIGS. 3 and 4, the original image 58 corresponds with the array of memory locations of the memory 44. In addition, the output image 64 corresponds with the array of memory locations of the memory 44. It should be appreciated that it is not critical or essential that the memory be laid out to correspond with the physical dimensions of a frame. In alternative implementations, the memory may have any number of rows and columns such that the total number of memory locations provides a sufficient number of memory locations to store a frame. For instance, the present example could have been illustrated with a memory having four columns and thirty-two rows. Similarly, it is not critical or essential that pixels be defined by eight bits or that a frame be an 8×16 array of pixels. The principles of the invention described herein may be practiced with pixels defined by any number of bits and images of any size.

Unmodified pixels of the original image may be stored in the memory 44 so that they are arranged in raster order. In the example of FIGS. 3 and 4, the first area 60 may be stored without modification, i.e., replicated, as the unmodified region 66 at memory addresses 00h to 3Fh. While individual pixels of the original image may be stored in raster order, the pixels may be stored in any desired order such that when the full original image is stored they are arranged in raster order. For instance, the individual pixels may be stored according to an interlaced scanning technique. In alternative embodiments, pixels of unmodified region 66 may be stored in memory 44 such that they are arranged in other orders than raster order.

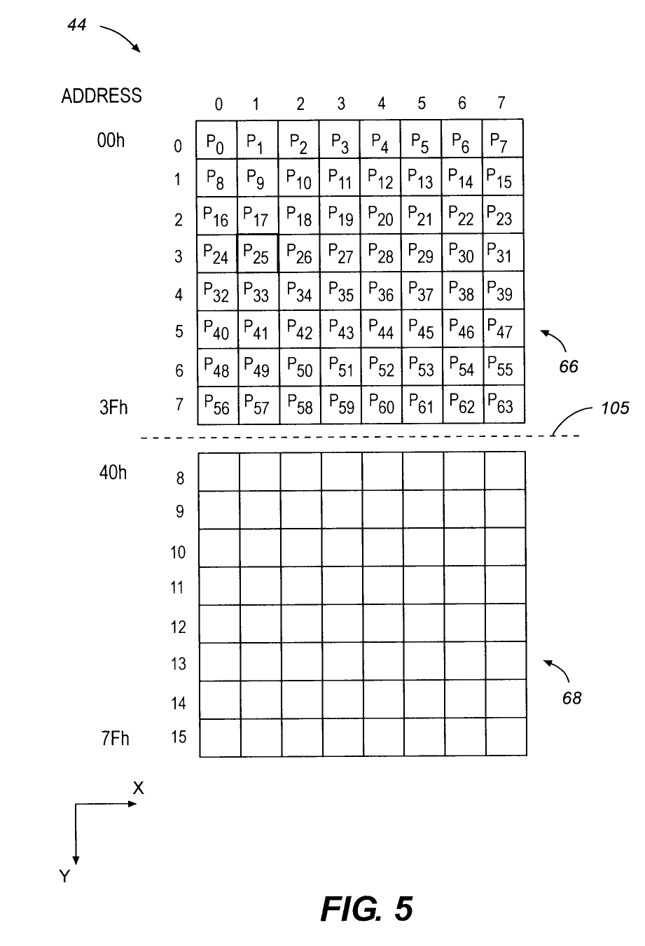

FIG. 5 is an alternative depiction of the memory 44. In this view, the pixels of the first area 60 of the original image 58 are numbered in raster sequence as P_{0 to P}₆₃. FIG. 5 shows what the contents of the memory 44 would look like after the first area 60 of the original image 58 has been stored in the portion of the memory 44 reserved for the unmodified region 66 if the calculating unit 52 stored no modified pixels in the portion of the memory reserved for the modified region 68. However, as described below, the calculating unit 52 stores modified pixels, so FIG. 5 does not show all aspects pixel data storage. FIG. 5 illustrates that the first area 60 may be stored in the memory without modification.

In one embodiment, the calculating unit 52 stores modified pixels in the memory 44 in a manner which results in the pixels being arranged in a bottom-up raster scan order. In the example of FIGS. 3 and 4, modified pixels generated by the calculating unit 52 may be stored at memory addresses 40h to 7Fh. The bottom-up raster scan pattern is illustrated in FIG. 6. The bottom-up raster scan pattern begins with the left-most pixel on the last line of an image. The bottom-up raster scan pattern proceeds pixel-by-pixel from left to right. When the right-most pixel on a line is reached, the bottom-up raster scan pattern jumps to the left-most pixel on the next higher line. The bottom-up raster scan pattern proceeds from the bottom line to each successively higher line until it reaches the right-most pixel of the top line. While individual modified pixels may be stored in bottom-up raster order, the pixels may be stored in any desired order such that when the full modified image is stored the pixels are arranged in bottom-up raster order. For instance, the individual modified pixels may be stored according to an interlaced scanning technique. In alternative embodiments, modified pixels for the region 68 may be stored in memory 44 such that they are arranged in other orders than bottom-up raster order.

Referring again to FIG. 1, the exemplary buffer 50 may have the capacity to store one full line of an output frame. In an alternative embodiment, the buffer 50 may have the capacity to store less than a full line. For example, the buffer 50 may have the capacity to store eight pixels of a 640 pixel line. As the pixels of an original frame 58 are received from the camera module 24 in raster order, each pixel may be stored in both the memory 44 and the buffer 50. As described below, after the buffer 50 is filled, the calculating unit 52 may then begin storing modified pixels in the memory 44.

An original frame of pixels may be provided to the display controller by the camera module 24, the host 22, or another source. (Frames output by the host 22 or by some other image source may also be referred to in this description as “original” images or frames.) Where the host 22 provides a frame, it may provide the frame directly or indirectly. For instance, the host may provide a frame indirectly by causing an original frame stored in the memory 30 to be provided to the display controller.

The display controller includes multiplexers 56 and 70 for selecting an original frame source. The multiplexer 56 is coupled with the camera data interface 42 via the data bus 54 and with the host interface 34 via a data bus 72. Similarly, the multiplexer 70 is coupled with the camera data interface 42 via a signal line 74 and with the host interface 34 via a signal line 76. Pixel data are placed on the busses 54 and 72, respectively, by the camera data and host interfaces 42, 34. When data placed on the bus 54 is available for sampling, the camera data interface 42 provides a data valid signal (“DV1”) on line 74. Similarly, when data placed on data bus 72 is available for sampling, the host interface 34 provides a data valid signal (“DV2”) on the line 76. Thus, the multiplexer 56 is used to select one of the data sources, and the multiplexer 70 is used to select a corresponding data valid signal. The selected pixel data is output from the multiplexer 56 on a bus 78. In addition, the selected data valid signal is output from the multiplexer 70 on a control line 80.

The output of multiplexer 70 on line 80 may be referred to as a data valid signal (“DV”). The DV signal may be provided to multiplexers 82 and 57. The DV signal may also be provided to an address generator 86, the buffer 50, and the calculating unit 52.

The multiplexer 82 may select one of two addresses to be used to store pixel data in the memory 44. In addition, the multiplexer 57 may select either an original image pixel or a modified pixel for storing in the memory 44.

The address generator 86 may generate memory addresses in raster sequence that may be used for storing original image pixels in the memory 44. An assertion of the data valid signal may cause the address generator 86 to generate a next sequential memory address in raster order. The output of the address generator 86 may be coupled with one of the data inputs of multiplexer 82.

The multiplexer 82 serves to select a memory address for storing an original image pixel or a modified pixel. One data input of the multiplexer 82 is coupled with the output of the address generator 86. Another data input of the multiplexer 82 is coupled with an address generator 90 in the calculating unit 52 via an address bus 88. A select input of the multiplexer 82, in one embodiment, may receive the DV signal. In one embodiment, an assertion of the DV signal may select the data input of the multiplexer 82 coupled with the address generator 86, and a de-assertion of the DV signal may select the data input of the multiplexer 82 coupled with the bus 88.

The multiplexer 57 may select either an original image pixel or a modified pixel for storing in the memory 44. One data input of the multiplexer 57 is coupled with the data bus 78 and another data input coupled with a data bus 92. As mentioned, original pixel data is output on the bus 78. Modified pixel data is output on the data bus 92 by the calculating unit 52. In one embodiment, an assertion of the DV signal may cause the data input of the multiplexer 57 coupled with the bus 78 to be selected, and a de-assertion of the DV signal may cause the data input of the multiplexer 57 coupled with the bus 92 to be selected.

In one embodiment, then, on assertions of the DV signal, a next raster-ordered sequential memory address may be placed on the address inputs (“AD”) and an original image pixel is placed on the data inputs (“DA”) of the memory 44. Thus, original image pixel data may be stored at raster-ordered addresses in the memory 44 synchronously with the DV signal.

Modified pixel data may be stored in bottom-up raster-ordered addresses in the memory 44 synchronously with de-assertions of the DV signal. In one embodiment, when the DV signal is de-asserted, the calculating unit 52 may output a modified pixel on bus 92 and its associated address on bus 88. In addition, in one embodiment, a de-assertion of the DV signal may cause the multiplexers 57 and 82 to respectively select their input coupled with the calculating unit 52. In particular, the multiplexer 57 selects bus 92 and multiplexer 82 selects bus 88. Further, in an alternative embodiment, a select signal may be provided to the multiplexers 57 and 82 by the calculating unit 52.

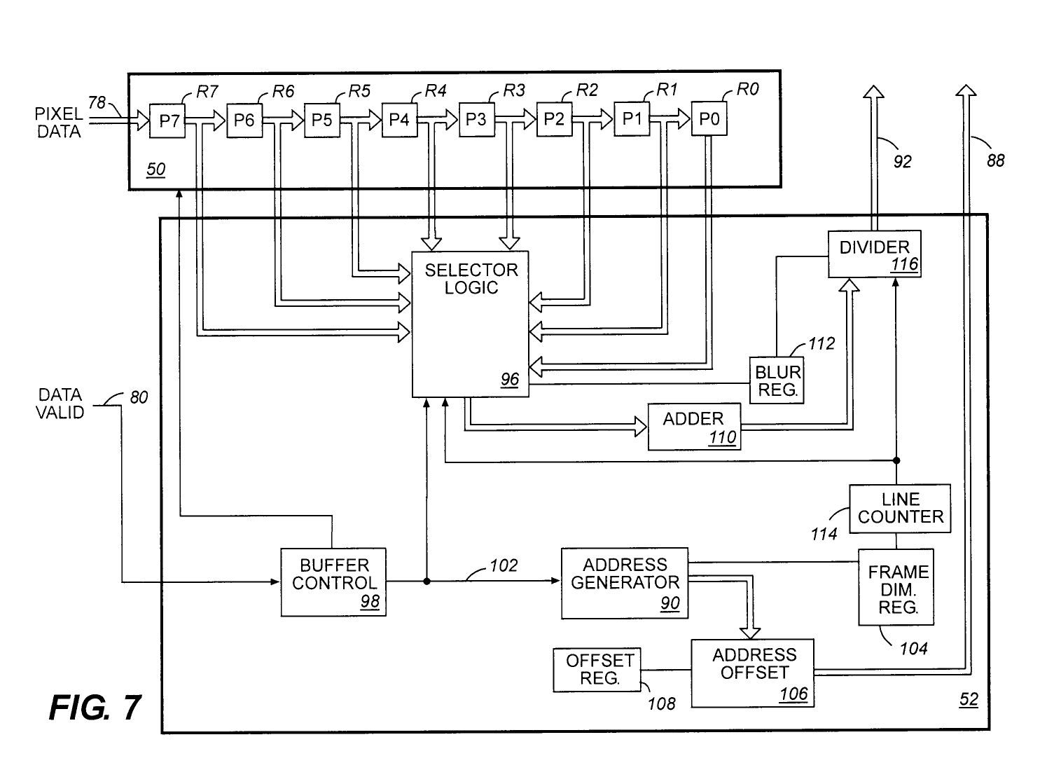

FIG. 7 shows in greater detail one exemplary embodiment of the buffer 50 and calculating unit 52. In FIG. 7, the exemplary buffer 50 includes eight registers R0-R7, each for storing one original image pixel. In this simplified example, the buffer 50 is assumed to have a size sufficient to store one line of pixels an original 8×16 image. One of the registers, e.g., register R7, may be coupled with the bus 78. In addition, the registers may be coupled together in series so that a pixel in one register may be transferred to an adjacent register. In one embodiment, the registers may be arranged as a serial-in-serial-out shift register. The DV signal on line 80 may be provided to a buffer control circuit 98. As described below, the buffer control circuit 98 may cause pixel data on the bus 78 to be stored in the register R7. In addition, the buffer control circuit 98 may also cause pixel data stored in the registers R0-R7 to be shifted to the right. The registers R0-R7 are also coupled with selector logic 96. The selector logic 96 may read the pixel data out of any of the registers.

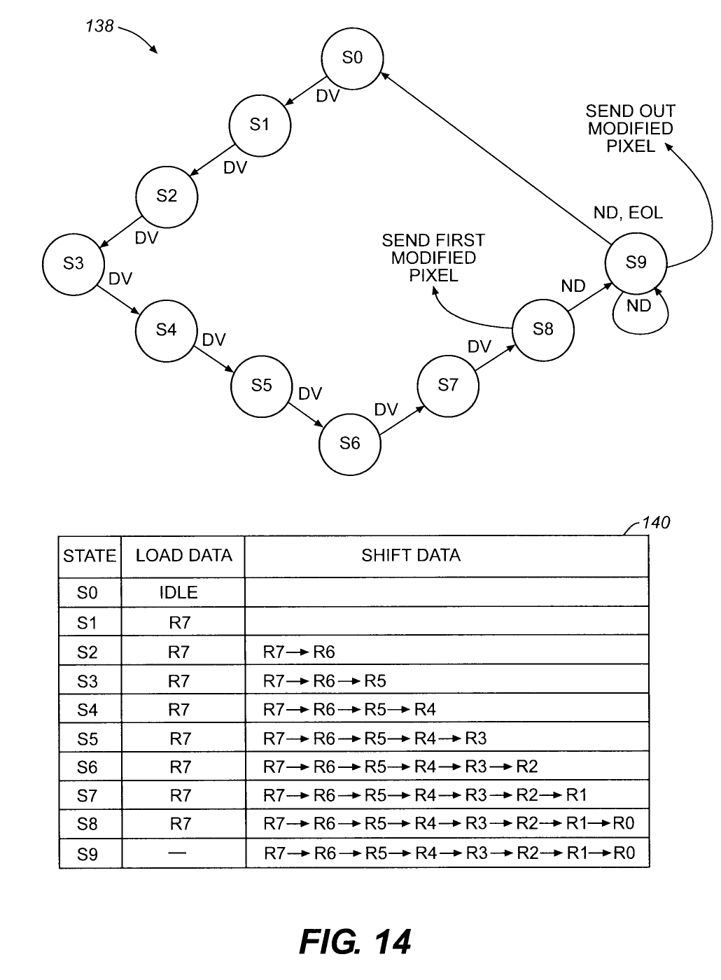

Referring to FIG. 14, one embodiment of a state diagram 138 for the buffer control circuit 98 is shown. The state diagram 138 includes an idle state SO, where the circuit waits for a DV signal. When a DV signal is detected, the buffer control circuit 98 advances from idle state S0 to state S1. As shown in the figure, if the control circuit 98 is in one of the states S0 to S7 and the DV signal is detected, the circuit advances to the next sequential state. Additionally, if the control circuit 98 is in state S8, the circuit advances to state S9 on detection of a new data (ND) signal (or other suitable signal). Further, if the circuit is in state S9, the control circuit 98 re-enters the state S9 when the ND signal is detected unless an end of line condition (EOL) is also detected. If both ND and EOL are detected, the buffer control circuit 98 returns to the idle state S0.

Table 140 shows the data loading and data shifting functions that may occur in each state S0 to S9. In state S1, the buffer control circuit 98 may cause a pixel to be loaded into the register R7. Because the embodiment shown in FIGS. 7 and 14 assume a simple example in which a line of an original image is eight pixels, a first pixel P0 of a line may be loaded into the register R7 in state S1. In state S2, the buffer control circuit 98 may cause the pixel data stored in register R7 to be copied into register R6 and a second pixel P1 of the line to be loaded into the register R7. Similarly, in states S3 to S8, pixel data is copied from and to the registers indicated in table 140, and a next sequential pixel datum of a line is stored in the register R7. In state S9, pixel data is copied from and to the registers indicated in table 140, however, pixel data is not stored in the register R7. In this example, the states S1 to S8 fill the buffer 50 with one line of pixel data. When the buffer control circuit 98 reaches state S8, the buffer contains the values shown in FIG. 7, i.e., one line of pixel data.

In states S8 and S9, modified pixels are generated as described below. In state S8, a first modified pixel of a line is generated, while in state S9, a new modified pixel is generated on each assertion of ND (or another suitable signal) until EOL is detected.

Referring again to FIG. 7, after the buffer 50 has been filled (or at least partially filled) with pixel data, the generation of modified pixels may begin. In the shown embodiment, the buffer control circuit 98 is coupled with the selector logic 96 and an address generator 90 via a line 102. After the buffer 50 is full, the circuit 98 signals the selector logic 96 to select particular pixels stored in one of more of the registers R0-R7 for use in generating a modified pixel. In addition, the circuit 98 signals the address generator to generate an address for the modified pixel. Address and modified pixel generation are further explained in turn below.

In one embodiment, the address generator 90 generates addresses in bottom-up raster order. The address generator 90 may be coupled with a register 104 which stores the horizontal and vertical dimensions of a frame. In addition, the register 104 may store an initial address. Each time a modified pixel is generated, the address generator 90 may use the frame dimensions to increment addresses in bottom-up raster order.

In one alternative (not shown), the address generator 90 may be coupled with the output of the address generator 86. The address generator 86 may output addresses in raster sequence. In this alternative, the address generator 90 converts each raster ordered address that it receives from the address generator 86 into a corresponding bottom-up raster ordered address.

Writing pixels of an original image to bottom-up raster ordered addresses of a memory effectively maps original image pixels into pixel locations reflected about an axis separating the two regions. The correspondence between the coordinate positions of raster ordered pixels of an unmodified region 66 with the coordinate positions of the bottom-up raster ordered pixels of a modified region 68 may be referred to as a reflection mapping function.

If the coordinate position of a raster ordered pixel in FIG. 5 is expressed in the notation P(x, y), then the converted coordinate position of the corresponding bottom-up raster ordered address pixel may be expressed as:

P_{conv}(x, y)=P(x , y+v) Eq. 1

where p(x , y) is the coordinate position of the raster ordered original pixel, and v is a vertical distance having a value that depends on the value of y. Referring to FIG. 5, consider raster ordered pixel P₅₆ in the unmodified region; its coordinates are P(0, 7). Assume, for example, that for y=7, v=1. Because y=7, the coordinate position of the bottom-up raster ordered pixel that corresponds with pixel P_{56 is P}_{conv}(0, 7+1) or P_{conv}(0, 8). As another example, consider raster ordered pixel P₀ in the unmodified region; its coordinates are P(0, 0). Assume that for y=0, v=15. Because y=0, the coordinate position of the bottom-up raster ordered pixel that corresponds with P_{0 is P}_{conv}(0, 0+15) or P_{conv}(0, 15). The values for the vertical distance v as a function of y depend on the position of the axis 105 and the vertical dimension of the full image. (In an alternate numbering scheme, the axis 105 takes a zero value with the y coordinates of pixels in the unmodified image taking positive values which increase with distance from the axis, and the y coordinates of pixels in the modified image taking negative values which increase with distance from the axis. In this numbering scheme, line 0 takes the y value +8, and line 15 takes the y value of −8.) A register (not shown) may be provided for storing the values of vertical distance v as a function of y. Such a register may include a table having one v entry for each line of the modified region 68. In one alternative, the vertical distance v may be defined by a function and the register stores parameters that define the function.

While an example of vertical mapping with respect to a horizontal axis has been described, in one embodiment, pixels may be mapped horizontally with respect to a vertical axis.

In addition to the reflection mapping function, an offset mapping function may be employed when generating addresses for modified pixels. Referring again to FIG. 7, an address offset unit 106 is coupled with the address generator 90. The address offset unit 106 may be coupled with a register 108, which stores parameters defining various address offsets. The address offset unit 106 translates an address output by the address generator 90 into a new address using the parameters stored in the register 108. The address offset unit 106 may translate a particular address horizontally or vertically. In the present example, the address offset unit 106 translates addresses horizontally, and a particular pixel may be translated one or more positions to the right or left. If the coordinate position of a modified pixel is expressed in the notation P_{conv}(x, y), then the translated coordinate position of pixel P_{cv/tr}(x, y) is:

P_{cv+tr}(x, y)=P_{conv}(x+h, y) Eq. 2

where h is a horizontal distance of translation. The translation of addresses exemplified by equation 2 may be referred to as an offset mapping function. The horizontal distance of translation h need not be a constant. The amount a pixel is translated may depend on the particular line on which the modified pixel is located. In one embodiment, the register 108 may store a table having one h entry for each line of the modified region 68. In an alternative embodiment, the horizontal distance h may be defined by a function and the register 108 stores parameters that define the function, as further described below. In addition, in one alternative, the address offset unit 106 may translate addresses vertically, and a particular pixel may be translated one or more positions up or down in a column.

Turning now to the generation of modified pixels, in one embodiment, the pixel data value of a modified pixel P′_{N} may be given by equation 3.

$${P}_{N}^{′} = \frac{{P}_{N} + {P}_{N + 1} + … + {P}_{N + M}}{D} \qquad Eq . 3$$

The denominator D is equal to the number of pixels in the numerator. Thus, the modified pixel P′_{N} may be an average of an original image pixel P_{N} and one or more of the original pixel's neighbors. As one example, referring again to FIG. 5, a modified pixel P′₀ may be the average of the original image pixel P₀ and one or more of its neighbor to the right, i.e., original image pixel P₁.

$${P}_{0}^{′} = \frac{{P}_{0} + {P}_{2}}{2}$$

The number of pixels that are averaged may include two, three, or more pixels. Further, the range of pixels which are averaged may include pixels to the left or right of the original image pixel. A user may desire to create an output image in which pixels of the first area 60 are reflected and translated, but not blurred. In addition, a user may desire to create an output image in which some but not all of the pixels of the first area 60 are blurred. Accordingly, the number of pixels that are “averaged” may be a single pixel.

Referring again to FIG. 7, the selector logic 96 selects and reads out pixel data corresponding with equation 3. It can be seen that the selector logic 96 may be coupled with an adder 110 and a register 112. The selector logic 96 may read pixel data from any one or more of the registers R0-R7. The adder 110 may sum the pixel data values read out by the selector 96. Which pixels are read out by the selector 96 and summed by the adder 110 may depend on the particular line on which the modified pixel is located. In this regard, the register 112 may store parameters defining the quantity and relative positions of pixels to be selected as a function of line number. In addition, the selector logic 96 may also be coupled with a line counter 114, which provides the current line number to the selector logic 96. The selector logic 96 may use the current line number and the parameters stored in register 112 to determine which pixel data to read out of the registers R0-R7.

A divider 116 may be coupled with the output of the adder 110, the register 112, and the line counter 114. The divider 116 divides the output of the adder 110 by a particular denominator. The denominator corresponds with the number of pixels read out by the selector logic 96 and summed by the adder 110. The divider 116 may use the current line number and the parameters stored in the register 112 to determine the appropriate denominator. The output of the divider 116 is a modified pixel value, which may be output on the bus 92.

The generation of a modified pixel P′_{N} by averaging an original image pixel P_{N} and one or more of the original pixel's neighbors may produce a blur effect. In alternative terminology, the averaging of an original image pixel with one or more neighboring pixels represents a blur function. In alternative embodiments, a variety of known blur functions may be employed. For example, a blur function that calculates a weighted average may be used. In another alternative, the pixels from two or more adjacent lines may be buffered for use in an average calculation. For example, a current line (e.g., line 2) and an immediately preceding line (e.g., line 1) may be buffered. As another example, a current line (e.g., line 2), an immediately preceding line (e.g., line 1), and an immediately subsequent line (e.g., line 3) may be buffered. Where two or more adjacent lines are buffered, a modified pixel may be generated by averaging one or more neighboring pixels above, below, and horizontally adjacent to a current pixel.

In general, the degree that a current pixel is blurred depends on the number of neighbor pixels included in the averaging calculation. The number of neighbor pixels included in the averaging calculation need not be a constant. As mentioned, the number of neighbor pixels included may depend on the particular line on which the current pixel is located. In one embodiment, the register 112 may store a table having one parameter defining the number of neighboring pixels to be included in an averaging calculation for each line of the modified region 68. In one alternative embodiment, the number of neighboring pixels may be defined by a function and the register 112 stores parameters that define the function. In one embodiment, the function increases (or decreases) the number of neighboring pixels included in the averaging calculation (and thus the amount of blur) with increasing distance from the axis. The function may change the number of pixels included in the averaging calculation on a line-by-line basis, or pixels may be grouped into bands of two or more lines and the function may change the number of pixels on a band-by-band basis. In one embodiment, the blur function may vary sinusoidally by line or band.

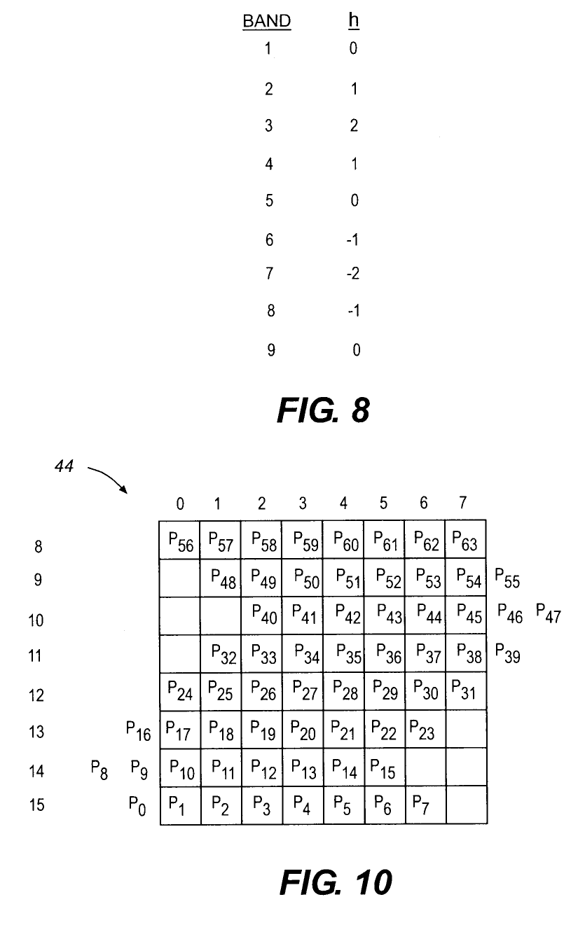

FIG. 8 shows one simplified example of parameters that may be stored in the register 108. As described above, the address offset unit 106 may translate each address output by the address generator 90 into a translated address and the register 108 may store offset parameters h defining various address offsets. In addition, as noted above, the parameter h specifies a horizontal distance of translation, which need not be a constant, i.e., the amount a pixel is translated may depend on the particular line on which the modified pixel is located. In one embodiment, the register 108 may store a table having one h entry for each line of the modified region 68. Further, in one embodiment, consecutive lines may be grouped into bands and the horizontal distance h may be the same for each line in the band. In addition in one embodiment, the horizontal distance h may be periodic and the register 108 stores parameters that define the periodic function. The example shown in FIG. 8 describes a sinusoidal function with a period of eight lines or bands. Beginning with the ninth band the function repeats.

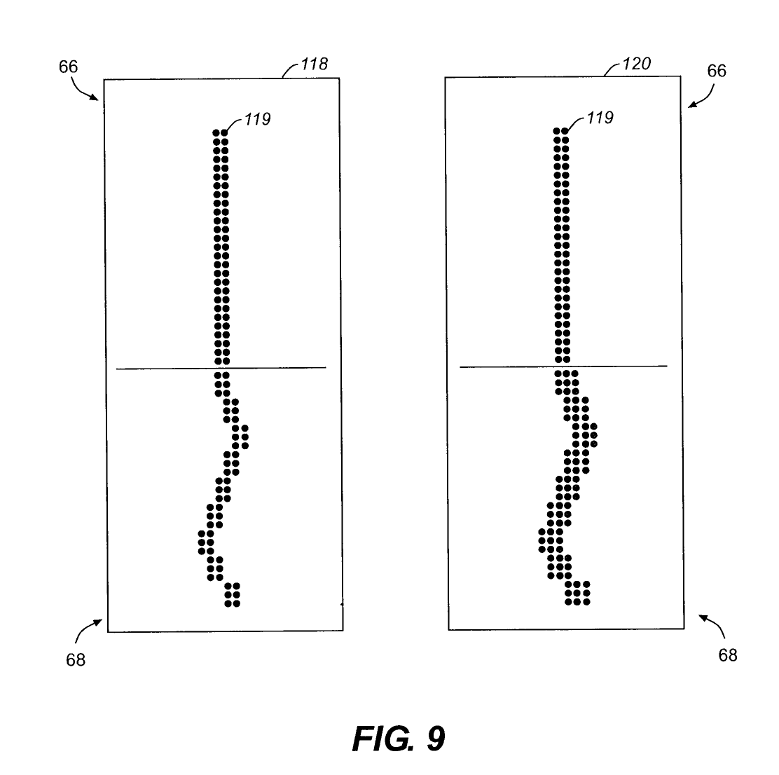

Referring to FIG. 9, simplified representations of exemplary output images are shown. In a frame 118, an unmodified region 66 comprises a vertical column of pixels 119. The modified region 68 comprises the pixels of the unmodified region 66 having been mapped, according to a reflection function, to corresponding coordinate positions in bottom-up raster order, and then translated, according to an offset mapping function, one or more positions to the right or left according to the exemplary horizontal distance parameters. In this example, one band equals three lines and the exemplary horizontal distance parameters h shown in FIG. 8 are used in the offset mapping function.

The frame 120 comprises the same unmodified region 66 that is shown in frame 118. The modified region 68 of frame 120 comprises modified pixels generated according to the same reflection and offset mapping functions shown in frame 118. In addition, a blur function has been applied to the modified region 68 of frame 120. The blur function includes averaging of unmodified pixel values with one neighbor to the pixel's right to produce a blur effect. In this example, the degree of blur is the same for each band of the modified region 68.

FIG. 10 illustrates that, due to applying an offset mapping function, a pixel may not be generated for every location in a modified region 68. FIG. 10 shows what the contents of the memory 44 would look like after the first area 60 of the original image 58 has been stored in reverse raster order in the portion of the memory 44 reserved for the modified region 68 and then translated one or more positions to the right or left according to a mapping function that uses the exemplary horizontal distance parameters shown in FIG. 8. On every line where the horizontal offset is non-zero, one or more pixels are mapped to locations outside of the memory 44. For instance, there is no location in the memory 44 to map the pixel P₀ on line 15. Moreover, on every line where the horizontal offset is non-zero, there are one or more memory locations for which no original image pixel is mapped, e.g., no pixel is mapped to the memory location corresponding with the coordinate location (7, 15). In one embodiment, the calculating unit 52 may determine that it is required to store in the memory 44 a modified pixel at a particular coordinate location, e.g., location (7, 15), but the necessary pixel data in the buffer 50 is lacking. In response to making this determination, the calculating unit 52 may compute a modified pixel using particular data present in the buffer 50, even though a blur function does not ordinarily contemplate using such data for generating a modified pixel for the particular location. In other words, a modified pixel may be generated using adjacent pixel data. For example, if the pixel data needed to generate a modified pixel for the coordinate location (7, 15) is unavailable, but the pixel data needed to generate a modified pixel for the coordinate location (6, 15) is available, the latter data may be used to generate a modified pixel for the former coordinate location. In other words, the modified pixel generated for location (6, 15) may be replicated at location (7, 15). While this approach represents an approximation, the fact that an approximation is used may often be difficult to perceive. In addition, this approach is preferable to cropping the output image, which can cause problems in various other devices and modules because standard-sized frames are expected by such devices.

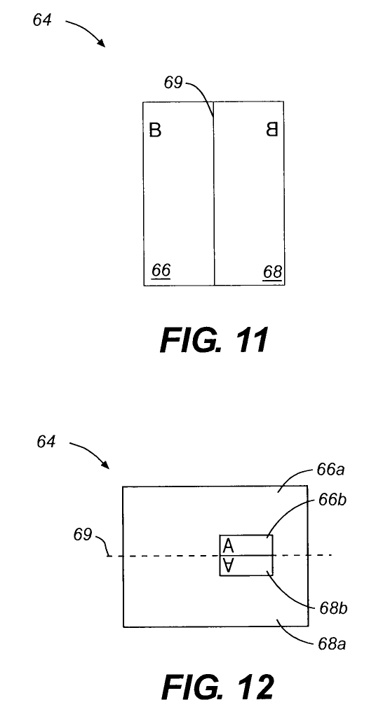

The examples presented in this specification describe storing and processing data in raster and bottom-up reverse raster orders. In particular, the examples have described a vertical mapping about a horizontal axis resulting in a vertical reflection. In one alternative, an axis 122 dividing an output image into an unmodified region and a modified region may be horizontal as shown in FIG. 11. In this alternative, the order for storing and processing data may be rotated ninety degrees from the raster and bottom-up reverse raster sequences.

FIG. 12 shows another example of an output image 64 that may be generated by the display controller 26 from an original image 58. Like the example shown in FIG. 3, the output image 64 of FIG. 12 includes an unmodified region 66 and a modified region 68. In this example, however, the unmodified region 66 is comprised of unmodified sub-regions 66a and 66b. The unmodified region 66 corresponds with the first area 60 of the original image 58 shown in FIG. 3. As shown in FIG. 3, a first area 60 of an original image 58 may be replicated, e.g., stored in memory, as the unmodified region 66. In this case, the first area 60 of an original image 58 may be replicated as unmodified sub-regions 66a and 66b.

In FIG. 12, the modified region 68 is comprised of modified sub-regions 68a and 68b. As shown in FIG. 3, a first area 60 of an original image 58 may be mapped into the modified region 68 of an output image 64 by storing pixel data such that it is arranged in bottom-up reverse raster order. Unlike the example of FIG. 3, in this case only a portion of the first area 60 is mapped into the modified region 68. Specifically, the portion of the first area 60 corresponding with the unmodified sub-region 66b is mapped into modified sub-region 68b. The modified pixels that make up modified sub-region 68b may be generated according to one of more of the reflection, offset, or blur functions described herein. In addition, the portion of the second area 62 corresponding with the modified sub-region 68a, may be replicated, e.g., stored in memory without modification. In other words, FIG. 12 illustrates that the reflection effect may, in one embodiment, be applied to any particular sub-region of a frame.

Referring once again to FIG. 1, the display controller 26 may include a clock 27. Conventionally, the internal clock 27 generates at least one clock signal having a frequency that is three to four times faster than either a camera clock rate or a display clock rate. As one example, the internal clock 27 may have a frequency of 54 MHz and the camera clock a frequency of 18 MHz. Camera clock rate refers to the particular rate at which the camera module 24 transfers an original image to the display controller. Display clock rate refers to the particular rate at which the display device accepts image data from the display controller.

For any particular embodiment, the number of internal clock cycles necessary to store an original image received from the camera module 24 in the memory 44 in a conventional manner may be readily determined. Similarly, the number of internal clock cycles necessary to read out an original image from the memory 44 for presentation to the display device 28 in a conventional manner may be readily determined. Depending on the particular implementation, each memory write and read transaction will require a predefined number of internal clock cycles. For example, a memory write transaction may require four internal clock cycles. If an original image contains 640 lines and each line contains 480 pixels, the original image may be stored in the memory 44 according to known methods in 307,200 memory write transactions, assuming that one pixel may be stored in one write transaction. Thus, if a memory write transaction requires four internal clock cycles, then 4×307,200=1,228,800 clock cycles would be required to store the 640×480 original image. The number of internal clock cycles needed to read the image may be determined in a similar manner.

When an output image is generated from an original image according to the principles of the invention, the number of internal clock cycles needed to store the output image in memory may increase very modestly. Because the output image generally contains the same number of pixels as the original image, the same number of memory write transactions is required to store either the original image or the output image. The number of internal clock cycles necessary to generate and store the output image may be slightly greater for the output image, however, than is required for the original image. The reason is that the writing to memory 44 of modified pixels for the modified region of the output image may be delayed by a number of clock cycles required to fill (or partially fill) the line buffer 50. Thus, the number of internal clock cycles necessary to generate and store an output image may be equal to the number of internal clock cycles needed to store an original image plus some additional number of clock cycles that are required to fill the line buffer 50. (It may be noted that when an output image is generated and stored in the memory 44, there is no increase in the number of internal clock cycles needed to read the output image from the memory over that which is conventionally required for an original image.)

As a first example, assume that a memory write transaction requires four internal clock cycles, that a frame is an 8×16 array of pixels, and that the eight pixel buffer 50 shown in FIG. 7 is employed. The number of internal clock cycles needed to store the original image in memory would be 8×16×4 cycles/write, assuming that one pixel may be stored in one write transaction, or 512 clock cycles. Accordingly, the number of internal clock cycles needed to store the output image in memory is 512 clock cycles plus some additional number of clock cycles that are required to fill the line buffer 50. Filling the line buffer requires storing eight pixels or 32 clock cycles (8×4=32). Thus, generating an output image have a reflection effect according to principles described herein would increase storing time by six percent (32/512). (It may be seen that this percentage is independent of the number of clock cycles required to perform a write transaction. For example, the original image includes 128 pixels, one line includes 8 pixels, and 8/128=0.06.) This simple example, however, is not typical.

In more typical examples, it may be seen that generating an output image have a reflection effect increases storing time by well under one percent. As a first example, consider a 640×480 frame size and a line buffer sized to store one full line. The generation and storing of the output image would require increasing in the number of internal clock cycles by 480 times the number of number of internal clock cycles per memory write transaction. In this example, the number of clock cycles would increase by about 0.2% (480/307,200=0.002). As another example, assume an original image resolution of 2,048×1,536 and a line buffer sized to store one full line. In this case, the number of clock cycles would increase by about 0.05% (1,536/3,145,728=0.0005).

Moreover, as mentioned above, the line buffer 50 need not be sized to store one full line. For example, consider a 640×480 frame size and a line buffer sized to store eight pixels. In this case, to generate and store an output image would require increasing the number of internal clock cycles by eight times the number of number of internal clock cycles per memory write transaction. In this example, the number of clock cycles would increase by about 0.002% (8/307,200=0.00002). The size of the percentage increase will depend on, at least, the number of lines in the original image as well as whether the line buffer is used to store a full line or a portion of a full line.

Because the number of internal clock cycles needed to store an output image in the memory 44 may increase only very modestly over the storing of an original image in a conventional manner, an output image having a reflection special effect may be efficiently generated at the time of image capture. In general, for most original images the increase in internal clock cycles will not exceed at least one percent (1%), one tenth of one percent (0.1%), or even one hundredth of one percent (0.01%) of the clock cycles needed to store the original image according to known methods. When an output image having a reflection special effect is generated according to the principles of the invention, it is not necessary to increase the internal clock rate or to provide a powerful processor, such as is required with image manipulation software. Nor is it necessary to provide a large data memory for storing multiple image copies or a program memory for storing software.

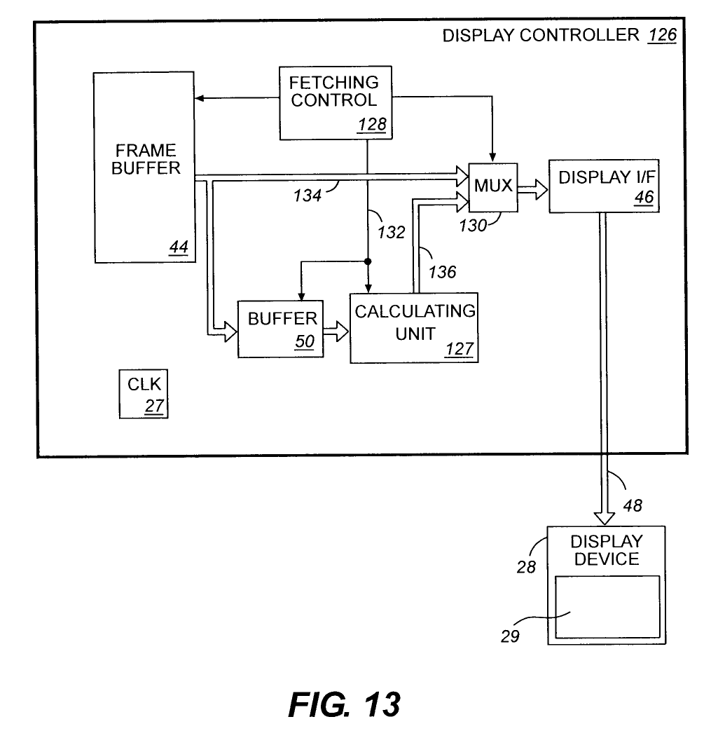

FIG. 13 is a simplified block diagram of one alternative embodiment of the display controller 26. While the display controller 126 shown in FIG. 13 may include one or more of the units shown in FIG. 1, such as the host interface 34 and the camera interfaces 36, 42, for simplicity, such units are not shown. The display controller 126 includes the clock 27, frame buffer 44, display interface 46, buffer 50, and a calculating unit 127. In addition, the display controller 126 includes a fetching control unit 128. In this embodiment, an original frame 58 may be stored in the memory 44 and an output frame 64 may be generated on the output side of the memory 44.

The fetching control unit 128 provides control signals and addresses for reading an original frame 58 stored in the memory 44. In addition, the fetching control unit 128 provides a select signal to a selecting unit 130, and a control signal on a line 132 to the buffer 50 and calculating unit 127. The selecting unit 130 includes a first data input coupled with the memory 44 via a bus 134. An output of the selecting unit 130 is coupled with the display interface 46. By asserting a first select signal, the fetching control unit 128 may cause the selecting unit 130 to pass particular pixel data of an original frame 58 fetched from the memory 44 and placed on the bus 134 to the display interface 46. For example, the first area 60 of the original image 58 shown in FIG. 3 may be passed directly to the display interface 46 as an unmodified region 66 of an output image 64. The fetching control unit 128, the display interface 46, or other logic not shown may provide, if necessary, addresses corresponding with pixel locations in the display area 29 of the display device 28 for pixels the first area 60. Such addresses correspond with the unmodified region 66 of the output image 64. In one embodiment, the first area 60, i.e., the unmodified region 66, may be transmitted to the display device in a particular sequence expected by the display device, e.g., raster order, without address information.

The buffer 50 is also coupled with the memory 44 via the bus 134. The fetching control unit 128 may cause the memory 44 to output particular pixel data, and cause the buffer 50 to sample the pixel data on the bus 134 by placing a control signal on the line 132. For example, the first area 60 of an original image 58 may be output and sampled by the buffer 50. In addition, the fetching control unit 128 may cause the calculating unit 127 to generate modified pixel data using original image pixel data stored in the buffer 50. The calculating unit 127 may generate modified pixel data according to the principles described herein. An output of the calculation unit 127 is coupled via a bus 136 with a second data input of the selecting unit 130. By asserting a second select signal, the fetching control unit 128 may cause the selecting unit 130 to pass modified pixel data from the calculating unit 127 to the display interface 46. The fetching control unit 128, the display interface 46, or other logic not shown may provide, if necessary, addresses corresponding with pixel locations in the display area 29 of the display device 28 for pixels the modified pixels. Such addresses correspond with the modified region 68 of the output image 64. In one embodiment, the modified region 68 may be transmitted to the display device in a particular sequence expected by the display device, e.g., raster order, without address information.

The original pixel data received by the selecting unit 130 on the bus 134 together with the modified pixel data received on the bus 136, in one embodiment, comprise an output frame 64 having a reflection special effect. When an output image is generated from an original image on the output side of the memory 44 as shown in FIG. 13, there is no increase in the number of internal clock cycles needed to store an original image over that which is conventionally required and the number of internal clock cycles needed to fetch and generate the output image from memory may increase modestly. For the same reasons discussed above for the embodiment shown in FIG. 1, the number of internal clock cycles necessary to fetch an output image is equal to the number of internal clock cycles needed to fetch an original image in a conventional manner. Moreover, in one embodiment, there may be no requirement to provide additional clock cycles to fill the line buffer 50; the line buffer 50 may be filled with a line (or portion thereof) of the original image while that line or another line of the first area 60 of the original image is being stored in the memory 44. In an alternative embodiment, the number of internal clock cycles necessary to transmit an output image to the display device may be equal to the number of internal clock cycles needed to fetch an original image plus some additional number of clock cycles that are required to fill the line buffer 50. In such alternative embodiments, the number of internal clock cycles needed to transmit an output image to the display device may increase by the same modest percentages described above. Accordingly, an output image having a reflection special effect may be efficiently generated at the time of image capture. In embodiments that apply the principles of the invention on the output side of the memory 44, it is not necessary to increase the internal clock rate or to provide a powerful processor, such as is required with image manipulation software. Nor is it necessary to provide a large data memory for storing multiple image copies or a program memory for storing software.

One difference between embodiments exemplified by display controller 26 and the display controller 126, is the speed and efficiency with which the display controller 126 can “undo” a reflection special effect. For instance, if after viewing an output image having a reflection special effect, the photographer may select an undo option which in turn generates an undo signal. In response to receiving the undo signal, the fetching control unit 128 may cause both the first and second areas 60, 62 of the original image 58 to be fetched from the memory 44 and transmitted to the display interface 46 without modification. With such an undo option, the original image, absent the reflection special effect, may be displayed at the time of image capture following an initial display of the output image having a reflection special effect.

According to the principles of the invention, an output image having a reflection special effect is defined by parameters stored in various registers. Simply by writing new parameter values to such registers the nature of the reflection special effect may be modified.

Because an output image having a reflection special effect may be generated in an very efficient manner as part of the typical capture and display process, it is possible to employ the principles of the invention with regard to video as well as still images. In particular, it will be appreciated that a video image having a reflection special effect may be generated at the time of image capture in a manner which only minimally increases hardware and power requirements. While video frame rates vary, generally speaking, a video image having a reflection special effect may be generated without increasing internal clock speed or providing a powerful processor, such as would be required with a software approach. In particular, video frame rates of 15 to 30 progressive frames or 30 to 60 interlaced frames may be accommodated without increasing internal clock speed. Moreover, a video image having a reflection special effect may be generated without a large data memory for storing multiple copies of video frames or a program memory for storing software.

As described herein an output image having a reflection special effect may be generated at the time of image capture of an original image. The phrase “at the time of image capture” is intended to refer to an entire conventional process beginning with the integration of light in an image sensor to the point where an image is ready to be, or in fact is, rendered on a display device. As should be clear from this description, the phrase “at the time of image capture” is not intended to refer to the time period during which light is integrated in an image sensor, which may correspond with a shutter speed of, for example, 1/60^{th} or 1/125^{th} of a second. Rather, the phrase is intended to refer to the time period a user conventionally experiences when an image is captured and displayed on a digital camera or a hand-held appliance having a digital camera. Such conventional time frames are typically on the order of one to several seconds, but may be shorter or longer depending on the particular implementation. As explained above the number of internal clock cycles generally increase by one percent or less. Because such increases are generally imperceptible to the user, he or she will perceive that the output image is generated at the time of image capture.

While the examples presented in this description may refer only to an output image being displayed on the display device 28, it should be appreciated that in alternative embodiments an output image may be transmitted to other devices and destinations. The output image may to be transmitted to another system or device for display for example. Additionally, the output image may be transmitted to a memory, such as the memory 30, where it may be stored. Moreover, the output image may be viewed on a display device and subsequently, such as where the user desires to retain a copy of the image, the output image may be stored in a memory. In such a case, the output image, the original image, or both the original and output images may be stored in memory. Further, a variety of output images having a reflection effect may be created by varying parameters and accordingly two or more output images created from a single original image may be stored in a memory.

It will be appreciated that the system 20 may include components in addition to those described above. In addition, the display controller 26 may include additional modules, units, or components. In order to not needlessly complicate the present disclosure, only modules, units, or components believed to be necessary for understanding the principles of the claimed inventions have been described.

In this description, the two-dimensional array comprising a frame has been referred to in terms of rows or lines (in the x direction) and columns (in the y direction). However, it should be understood that in this description and in the claims the terms “row” and “line” may refer to either or both a horizontal row or line (in the x direction) and a vertical row or line (in the y direction), i.e., a column.

In one embodiment, the calculating units 52, 127 may perform some or all of the operations and methods described in this description by executing instructions that are stored in or on machine-readable media. In addition, other units of the display controllers 26, 126 may perform some or all of the operations and methods described in this description by executing instructions that are stored in or on machine-readable media.

In this description, references may be made to “one embodiment” or “an embodiment.” These references mean that a particular feature, structure, or characteristic described in connection with the embodiment is included in at least one embodiment of the claimed inventions. Thus, the phrases “in one embodiment” or “an embodiment” in various places are not necessarily all referring to the same embodiment. Furthermore, particular features, structures, or characteristics may be combined in one or more embodiments.

Although embodiments have been described in some detail for purposes of clarity of understanding, it will be apparent that certain changes and modifications may be practiced within the scope of the appended claims. Accordingly, the described embodiments are to be considered as illustrative and not restrictive, and the claimed inventions are not to be limited to the details given herein, but may be modified within the scope and equivalents of the appended claims. Further, the terms and expressions which have been employed in the foregoing specification are used as terms of description and not of limitation, and there is no intention in the use of such terms and expressions to exclude equivalents of the features shown and described or portions thereof, it being recognized that the scope of the inventions are defined and limited only by the claims which follow.

1. A method for generating an output image having a reflection special effect from an original image, the original image having a first area, the output image having a modified and an unmodified region, and being generated using a memory having a capacity limited to storing a single image and a buffer having a capacity limited to storing one line of the original image, comprising:
storing the first area of the original image in the memory at memory locations corresponding with the unmodified region of the output image;
storing a part of the first area of the original image in the buffer;
storing modified pixels in the memory at memory locations corresponding with the modified region of the output image, the storing of modified pixels including:
generating modified pixels, each of the modified pixels being generated from one or more pixels of the part of the first area stored in the buffer, and
generating addresses identifying memory locations for storing each of the modified pixels according to a reflection mapping function and an offset mapping function; and
rendering the output image, the rendering including fetching the output image from the memory.

2. The method of claim 1, wherein the capacity of the buffer is limited to storing a portion of one line of the original image.

3. The method of claim 1, wherein the generating of modified pixels includes generating at least one modified pixel according to a blur function that includes calculating an average of a first pixel in the original image and at least one pixel in the original image neighboring the first pixel.

4. The method of claim 1, wherein the reflection mapping function reflects pixel locations about an axis of the output image and the offset mapping function translates at least one line of reflected pixel locations in a direction parallel to the axis.

5. The method of claim 4, wherein at least one of magnitude and direction of translation of the offset mapping function varies as a function of distance from the axis.

6. The method of claim 5, wherein the generating of modified pixels includes generating at least one modified pixel according to a blur function that includes calculating an average of a first pixel in the original image and at least one pixel in the original image neighboring the first pixel.

7. The method of claim 6, wherein the number of neighbor pixels included in the average varies as a function of distance from the axis.

8. An apparatus for generating an output image having a reflection special effect from an original image, the original image having a first area, the output image having a modified and an unmodified region, comprising:
a memory to store the output image, the memory having a capacity limited to storing a single output image;
a buffer having a capacity limited to storing one line of the original image;
a receiving unit to receive and store the first area of the original image in the memory and a part of the first area of the original image in the buffer, the first area being stored in the memory at memory locations corresponding with the unmodified region of the output image;
a calculating unit to:
(a) generate modified pixels for each pixel location of the modified region from one or more pixels of the part of the first area stored in the buffer, and
(b) store the modified pixels in the memory at memory locations generated according to a reflection mapping function and an offset mapping function; and
a fetching unit to fetch the output image from the memory and to transmit the output image to an output device.

9. The apparatus of claim 8, wherein the capacity of the buffer is limited to storing a portion of one line of the original image.

10. The apparatus of claim 8, wherein the generating of modified pixels includes generating at least one modified pixel according to a blur function that includes calculating an average of a first pixel in the original image and at least one pixel in the original image neighboring the first pixel.

11. The apparatus of claim 8, wherein the reflection mapping function reflects pixel locations about an axis of the output image and the offset mapping function translates at least one line of reflected pixel locations in a direction parallel to the axis.

12. The apparatus of claim 11, wherein at least one of magnitude and direction of translation of the offset mapping function varies as a function of distance from the axis.

13. The apparatus of claim 12, wherein the generating of modified pixels includes generating at least one modified pixel according to a blur function that includes calculating an average of a first pixel in the original image and at least one pixel in the original image neighboring the first pixel.

14. The apparatus of claim 13, wherein the number of neighbor pixels included in the average varies as a function of distance from the axis.

15. The apparatus of claim 8, wherein the apparatus generates a sequence of output images having a reflection special effect from a sequence of original images at a video frame rate.

16. A method for generating an output image having a reflection special effect from an original image, the original image having a first area, the output image having a modified and an unmodified region, and being generated using a memory having a capacity limited to storing a single image and a buffer having a capacity limited to storing one line of the original image, comprising:
storing the original image in the memory;
transmitting to an output device the unmodified region of the output image, the transmitting of the unmodified region including fetching the first area of the original image from the memory;
storing a part of the first area of the original image in the buffer; transmitting to the output device the modified region of the output image, the transmitting of the modified region including:
generating modified pixels, each modified pixel being generated from one or more pixels of the part of the first area stored in the buffer, and
providing the modified pixels for transmission in an order defined by a reflection mapping function and an offset mapping function; and
rendering the output image on the output device.

17. The method of claim 16, wherein the capacity of the buffer is limited to storing a portion of one line of the original image.

18. The method of claim 16, wherein the generating of modified pixels includes generating at least one modified pixel according to a blur function that includes calculating an average of a first pixel in the original image and at least one pixel in the original image neighboring the first pixel.

19. The method of claim 16, further comprising rendering the original image on the output device after the step of rendering the output image on the output device in response to an undo command.

20. An apparatus for generating an output image having a reflection special effect from an original image, the original image having a first area, the output image having a modified and an unmodified region, comprising:
a memory to store the original image, the memory having a capacity limited to storing a single original image;
a buffer having a capacity limited to storing one line of the original image;
a fetching unit to fetch pixels of the first area of the original image from the memory for transmission to an output device and to store the fetched pixels in the buffer;
a calculating unit to:
(a) generate modified pixels for each pixel location of the modified region from one or more pixels of the first area stored in the buffer, and
(b) to map the modified pixels into pixel locations in the display area of the output device according to a reflection mapping function and an offset mapping function; and
a transmitting unit to transmit the first area and the modified pixels to the output device as the output image.

21. The apparatus of claim 20, wherein the capacity of the buffer is limited to storing a portion of one line of the original image.

22. The apparatus of claim 20, wherein the calculating unit generates at least one modified pixel according to a blur function that includes calculating an average of a first pixel in the original image and at least one pixel in the original image neighboring the first pixel.

23. The apparatus of claim 20, wherein the transmitting unit transmits the original image to the output device as the output image in response to receiving an undo signal.

24. The apparatus of claim 20, wherein the apparatus generates a sequence of output images having a reflection special effect from a sequence of original images at a video frame rate.
